(19) United States
(12) Patent Application Publication
(10) Pub. No.: US 2023/0044695 A1
(43) Pub. Date: Feb. 9, 2023

(54) SYSTEM AND METHOD FOR A SCALABLE DYNAMIC ANOMALY DETECTOR

(71) Applicant: Onapsis Inc., Boston, MA (US)

(72) Inventors: Claudio Brandy, Boston, MA (US); Jimmy Masias, Boston, MA (US); Juan Pablo Perez Etchegoyen, Boston, MA (US)

(73) Assignee: Onapsis Inc., Boston, MA (US)

(21) Appl. No.: 17/845,438

(22) Filed: Jun. 21, 2022

Related U.S. Application Data
(60) Provisional application No. 63/212,790, filed on Jun. 21, 2021.

(51) Int. Cl. G06F 21/55; G06N 20/00

(52) U.S. Cl. CPC G06F 21/554; G06N 20/00; G06F 2221/033

(57) ABSTRACT

Security can be improved in a business application or system, such as a mission-critical application, by automatically analyzing and detecting anomalies for mission-critical applications. This detection may be based on a dynamic analysis of business process logs and audit trails that includes User and Entity Behavior Analysis (“UEBA”).

### PRIORITY

This application claims priority to U.S. Provisional App. No. 63/212,790, filed on Jun. 21, 2021, entitled “SYSTEM AND METHOD FOR A SCALABLE DYNAMIC ANOMALY DETECTOR”, the entire disclosure of which is herein incorporated by reference.

### TECHNICAL FIELD OF THE INVENTION

The present invention relates to anomaly detection for mission-critical applications.

### BACKGROUND

Businesses may rely on electronic systems using database technology to manage their key processes. There may be a number of business applications that businesses rely on that include mission-critical applications (MCAs). One example business application that may be an MCA is an Enterprise Resource Planning (ERP) system. Other example MCAs include Customer Relationship Management (CRM), Supply Chain Management (SCM), Product Lifecycle Management (PLM), Human Capital Management (HCM), Integration Platforms, Business Warehouse (BW)/Business Intelligence (BI) and Integration applications developed by SAP, ORACLE, MICROSOFT, SALESFORCE, NETSUITE, WORKDAY, SIEBEL, JD EDWARDS, PEOPLESOFT, and others. These applications are in charge of processing sensitive business data and, accordingly, the confidentiality, integrity and availability of this information is therefore critical for the security and continuity of the business. MCAs have historically been subject to diverse and complex security threats. Improper or inadequate security for those threats can endanger an application through loss of critical/protected data, loss of reputation, loss of business, lawsuits, etc. Therefore, it is important to effectively mitigate these risks.

### BRIEF SUMMARY

The present invention relates to a method, system or apparatus and/or computer program product for improved security by automatically detecting anomalies for mission-critical applications. This detection may be based on a dynamic analysis of business process logs and audit trails that includes User and Entity Behavior Analysis (“UEBA”).

The embodiments describe a system that includes data pipelines, data preparation modules, parsing modules, algorithms, engines, and one or more machine learning models.

The embodiments further describe a method that allows scalable and efficient anomaly detection over MCAs logs using machine learning models.

The embodiments further describe a method that allows scalable and efficient classification of events given their level of normality over MCAs using machine learning models.

The embodiments further describe a method that allows scalable and efficient anomaly scoring of events over MCAs using machine learning models.

The embodiments further describe a method that allows easily extending the system to support new MCAs by plugging new data pipelines and algorithms to represent the logging model of each MCA.

The embodiments further describe a method that allows extending the system to support new predicting capabilities by plugging new models.

### BRIEF DESCRIPTION OF THE DRAWINGS

The figures illustrate principles of the invention according to specific embodiments. Thus, it is also possible to implement the invention in other embodiments, so that these figures are only to be construed as examples. Moreover, in the figures, like reference numerals designate corresponding modules or items throughout the different drawings.

FIG. 1 illustrates a block diagram of an example network system.

FIG. 2 illustrates an example system architecture.

FIG. 3 illustrates another example system architecture.

FIG. 4 illustrates an example architecture of a modeling core component for training.

FIG. 5 illustrates an example architecture of a modeling core component for a scoring of business process events.

FIG. 6 illustrates an example contribution of each attribute of a business activity towards a final score of one example model.

FIG. 7 illustrates an example degree of normality of each attribute of a business activity.

DETAILED DESCRIPTION OF THE DRAWINGS AND PREFERRED EMBODIMENTS

By way of introduction, the disclosed embodiments relate to systems and methods for automatically or dynamically detecting anomalies for mission-critical applications (MCAs). This detection may be based on a dynamic analysis of business process logs and audit trails that includes User and Entity Behavior Analysis (UEBA). Examples of MCAs include, but are not limited to Enterprise Resource Planning (ERP), Customer Relationship Management (CRM), Supplier Relationship Management (SRM), Supply Chain Management (SCM), Product Life-cycle Management (PLM), Human Capital Management (HCM), Integration Platforms, Business Warehouse (BW)/Business Intelligence (BI) and Integration applications developed by SAP, ORACLE, MICROSOFT, SALESFORCE, NETSUITE, WORKDAY, SIEBEL, JD EDWARDS, PEOPLESOFT, and others. The embodiments described herein relate to the UEBA and dynamic anomaly detection between and among such business applications, including MCAs. The embodiments apply to MCAs and may be described with respect to specific examples, but are not limited to specific applications.

Mission-critical applications (MCAs) are subject to security scrutiny because of compliance regulations or because of the criticality of the stored information or the processes executed in the MCA. Depending on the type of application, the technical review may vary but may include anomaly detection and UEBA. For example, Sarbanes-Oxley Act of 2002 audits may require this type of assessment for the in-scope applications, i.e., the Enterprise Resource Planning system, the Human Capital Management system, the Customer Relationship Management system, the Business Warehouse/Intelligence system, etc.

MCAs keep track of the activities performed on them by users and other entities through the storage of logs and audit trails that record information of those activities. Technical, Security and Audit logs are critical to understanding the nature of security incidents during an active investigation and post mortem analysis. Logs and traces are also useful for establishing baselines, identifying operational trends, and supporting the organization's internal investigations, including audit and forensic analysis. In some cases, an effective audit logging program can be the difference between a low-impact security incident that is detected early on, before covered data is stolen or a severe data breach where attackers download a large volume of covered data over a prolonged period of time. Additionally, business process logs provide an audit trail of business activities that are executed on the MCAs and those logs can be used to model these business processes.

Analyzing these logs, which are continuously updated with new events that may amount to hundreds of millions per day, is a challenging task that goes beyond human analysis capabilities, so the embodiments below describe smart automation that could be applied to it helping to narrow down the potential relevant issues to look and enabling a human analysis scale, which may provide value to organizations.

User and Entity Behavior Analysis (UEBA) is a process that takes note of the normal conduct of: 1) Application users in general, including people that have an account with a defined role that allows them to interactively access a subset of the MCA's functionality to perform well-defined tasks; 2) system accounts that perform automated background processes and routine tasks involving workflows, inter-process communication, and others; and 3) terminals/computers that are used to connect to business applications by any type of user.

UEBA uses machine learning, algorithms, and statistical analyses to detect when there is a deviation from historical behavior patterns, showing which of these anomalies could result in a potential threat and qualifying them with a score. UEBA can also aggregate the data in the reports and logs, as well as analyze the file, flow, and packet information. For example, if a particular user regularly downloads 10 MB of files every day but suddenly downloads gigabytes of files, the system may detect this change in behavior (as a detected anomaly) and alert immediately. UEBA may not track isolated security events or monitor specific devices; instead, users' and entities' behaviors are tracked by means of system (or application) logs. UEBA may focus on insider threats, such as employees who show deceitful or unreliable conduct, employee accounts that have been compromised, and others who may have access to the system and carry out attacks and fraud attempts, as well as applications and devices related to the system.

UEBA, as a part of an organization's security system can detect:
Insider threats, performed by an employee or group of employees, stealing data and information by using their access. It can help to detect data breaches, privilege abuse, and policy violations made by an organization's staff.
Compromised accounts. Sometimes, user accounts are compromised. It could be that the user unwittingly installed malware on his or her machine, or sometimes a legitimate account is spoofed. UEBA can help to weed out spoofed and compromised users before they can do real harm.
Brute-force attacks. Malicious users sometimes target cloud-based entities as well as third-party authentication systems. With UEBA, brute-force attempts can be detected, allowing to block access to these entities.
Suspicious changes in permissions, showing accounts that were granted unnecessary permissions.
Creation of super users, alerting when super users are unusually created.
Breach of protected data. Access to protected data by users who do not have a legitimate business reason to access it.

The embodiments detect potential anomalies by modeling the behavior of users by means of the events recorded on the MCA's Traces, Security Logs and Audit Logs, combined with specific business context. As it may be assumed that both system accounts and login accounts perform tasks that are persistent in small to medium periods, the behavior models are used to quantify how much a given event deviates from the historical behavior of the associated user or entity. Accordingly, the models look to quantitatively answer the following questions:
What is the probability that a certain event that happened on a given application was performed by a specific user (or entity), typically captured in a “username” field?
For any new event and its correlated business context, are all the characteristics of the event and the business context consistent with the historical behavior of the user or entity listed as the actor in that event? By how much?
If an event does not correlate well with what is modeled as “normal behavior”, hence qualified as anomalous, which specific characteristics of the event and the executed business process make it so?
If a deviation from the normal business processes was detected, what is the business risk that is inferred from that deviation?

The embodiments do not exclusively answer only the questions above. Depending on the specific model in use, they may bring additional insights on the users and entities behavior over time.

The embodiments may include the following features:
It combines one or more machine learning algorithms to train models that learn the behavior of an MCA's users and entities, using log events as input as well as additional context from the system.
It is able to combine and weigh the output of two or more models, allowing for the fine tuning of the output scores and classifications.
The system can predict and, simultaneously, be trained in an online fashion, ingesting events into its Modeling Core as they arrive through the pipeline. This allows the system, depending on the selection of algorithms, to begin predicting as soon as it is started, with growing levels of accuracy, in contrast to other solutions that need large batches of events to pre-train its models.
The system is extremely efficient in terms of the time required to qualify a certain activity as a potential anomaly, which is a task that requires many hours of analysis by a human expert, but can be accomplished in milliseconds by the system.
It is easily extendable to cover multiple different types of MCAs, systems and applications using the same solution/system.
It is easy to design and maintain: the way a new model, using different algorithms and/or hyper-parameters, can be plugged into the component in order to supply additional scoring information, additional classification capabilities and other information, makes its potential evolution possible without affecting previously implemented models.
It handles categorical and numerical values transparently, all in an online way, not requiring to store or persist any event data on the system.
It incorporates anonymization: as it ingests data, it is anonymized and all models are built based on anonymized data, meaning there is no risk of exposure of any type of sensitive or personal data. Moreover, as the models do not store sensitive data, they can be shared across organizations to strengthen their security posture by combining profiles of users.
Given a stream of users and the system's activities, the invention creates an internal representation of concepts based on contextual proximity and connections. This provides the ability to identify what are the components of a user activity or a user profile that are more closely related to other concepts.
The system can identify “normality” of activity based on different perspectives such as historical activity by single events or by a combination of activities that were performed by the same user.
The activity performed by a user on a given Business Application is translated into business concepts which are higher-level abstractions that allow a business user to detect potential risks to a given business process.

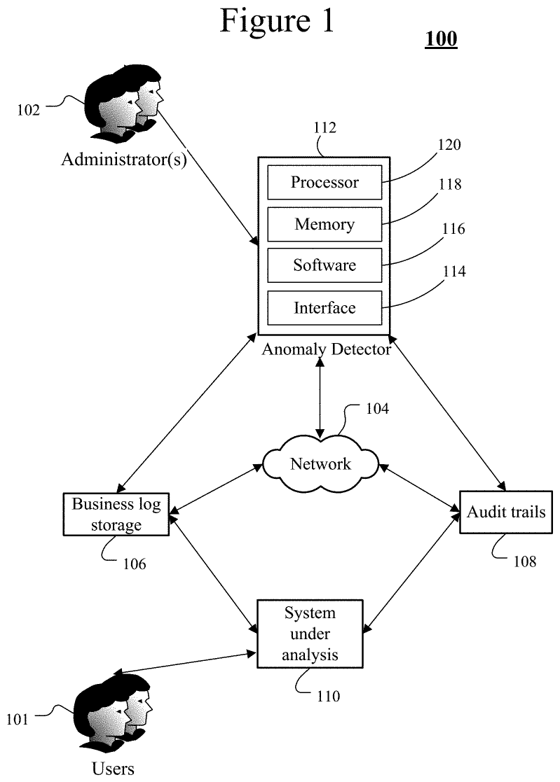

FIG. 1 illustrates a block diagram of an example network system 100. The system 100 may include functionality for automatic or dynamic anomaly detection based on behavior analysis. The behavior analysis may be based on data, such as business log storage 106 and/or audit trails 108. That data may be stored in one or more databases (not shown) for performing the detection. The detection may be performed by an anomaly detector 112. The anomaly detector 112 may include User and Entity Behavior Analysis (UEBA), which may also be a separate component.

Communications in system 100 may be over a network 104 that interconnects any of the components. For example, the data used for detection and the detection from the anomaly detector 112 may be communicated over the network 104. The network 104 may be an internal network, an external network, a local connection, a direct connection/interface, or a combination. The connections may be through an Application Programming Interface (“API”) and/or through a local agent (not shown). This connection may be made by mimicking a user or any other technique to extract the required information over the network 104.

The anomaly detector 112 may be a computing device. The anomaly detector 112 may be operated by users (e.g. administrators 102). In one embodiment, the anomaly detector 112 may be software that runs on a computing device as shown in FIG. 1. The anomaly detector 112 dynamically analyzes data (e.g. user behavior) from the system under analysis 110 used by the users 101. The anomaly detector 112 may include a processor 120, a memory 118, software 116 and a user interface 114. In alternative embodiments, the anomaly detector 112 may be multiple devices to provide different functions and it may or may not include all of the user interface 114, the software 116, the memory 118, and/or the processor 120.

The user interface 114 may be a user input device or a display. The user interface 114 may include a keyboard, keypad or a cursor control device, such as a mouse, or a joystick, touch screen display, remote control or any other device operative to allow a user or administrator to interact with the anomaly detector 112. The user interface 114 may communicate with any of the systems in the network 104, including the anomaly detector 112, and/or the business log storage 106, or the audit trails 108. The user interface 114 may include a user interface configured to allow a user and/or an administrator 102 to interact with any of the components of the anomaly detector 112 for behavior analysis and anomaly detection. The user interface 114 may include a display coupled with the processor 120 and configured to display an output from the processor 120. The display (not shown) may be a liquid crystal display (LCD), an organic light emitting diode (OLED), a flat panel display, a solid state display, a cathode ray tube (CRT), a projector, a printer or other now known or later developed display device for outputting determined information. The display may act as an interface for the administrator to see the functioning of the processor 120, or as an interface with the software 116 for providing data.

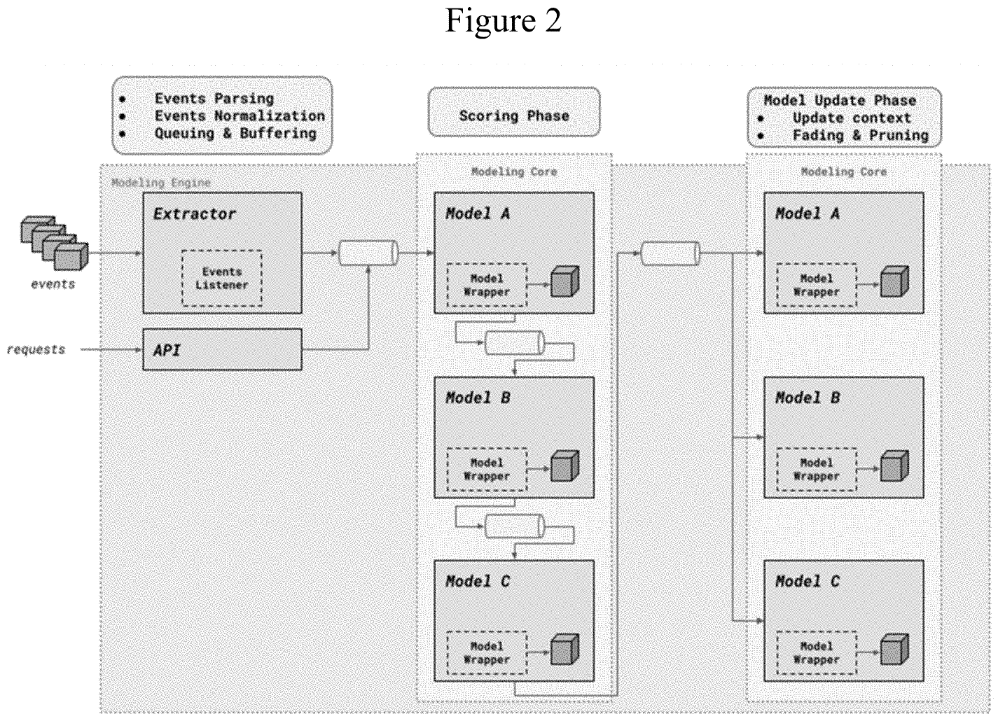

The processor 120 in the anomaly detector 112 may include a central processing unit (CPU), a graphics processing unit (GPU), a digital signal processor (DSP) or other type of processing device. The processor 120 may be a component in any one of a variety of systems. For example, the processor 120 may be part of a standard personal computer or a workstation. The processor 120 may be one or more general processors, digital signal processors, application specific integrated circuits, field programmable gate arrays, servers, networks, digital circuits, analog circuits, combinations thereof, or other now known or later developed devices for analyzing and processing data. The processor 120 may operate in conjunction with a software program (i.e. software 116), such as code generated manually (i.e., programmed). The software 116 may include anomaly detection as further described below, such as the examples described with respect to FIGS. 2-5.

The processor 120 may be coupled with the memory 118, or the memory 118 may be a separate component. The software 116 may be stored in the memory 118. The memory 118 may include, but is not limited to, computer readable storage media such as various types of volatile and non-volatile storage media, including random access memory, read-only memory, programmable read-only memory, electrically programmable read-only memory, electrically erasable read-only memory, flash memory, magnetic tape or disk, optical media and the like. The memory 118 may include a random access memory for the processor 120. Alternatively, the memory 118 may be separate from the processor 120, such as a cache memory of a processor, the system memory, or other memory. The memory 118 may be an external storage device or database for storing recorded tracking data, or an analysis of the data. Examples include a hard drive, compact disc (“CD”), digital video disc (“DVD”), memory card, memory stick, floppy disk, universal serial bus (“USB”) memory device, or any other device operative to store data. The memory 118 is operable to store instructions executable by the processor 120.

The functions, acts or tasks illustrated in the figures or described herein may be performed by the programmed processor executing the instructions stored in the software 116 or the memory 118. The functions, acts or tasks are independent of the particular type of instruction set, storage media, processor or processing strategy and may be performed by software, hardware, integrated circuits, firm-ware, micro-code and the like, operating alone or in combination. Likewise, processing strategies may include multiprocessing, multitasking, parallel processing and the like. The processor 120 is configured to execute the software 116.

The present disclosure contemplates a computer-readable medium that includes instructions or receives and executes instructions responsive to a propagated signal, so that a device connected to a network can communicate voice, video, audio, images or any other data over a network. In some embodiments, the connection (e.g. through the network) may be a local or direct connection between components that allows for local network traffic. The user interface 114 may be used to provide the instructions over the network via a communication port. The communication port may be created in software or may be a physical connection in hardware. The communication port may be configured to connect with a network, external media, display, or any other components in system 100, or combinations thereof. The connection with the network may be a physical connection, such as a wired Ethernet connection or may be established wirelessly as discussed below. Likewise, the connections with other components of the system 100 may be physical connections or may be established wirelessly.

Any of the components in the system 100 may be coupled with one another through a (computer) network, including but not limited to the network 104. For example, the anomaly detector 112 may be coupled with the source 106 and/or the destination 108 through the network 104 or may be coupled directly through a direct connection. In some ERP systems, the network 104 may be a local area network (“LAN”), or may be a public network such as the Internet. Accordingly, any of the components in the system 100 may include communication ports configured to connect with a network. The network or networks that may connect any of the components in the system 100 to enable communication of data between the devices may include wired networks, wireless networks, or combinations thereof. The wireless network may be a cellular telephone network, a network operating according to a standardized protocol such as IEEE 802.11, 802.16, 802.20, published by the Institute of Electrical and Electronics Engineers, Inc., or WiMax network. Further, the network(s) may be a public network, such as the Internet, a private network, such as an intranet, or combinations thereof, and may utilize a variety of networking protocols now available or later developed including, but not limited to TCP/IP based networking protocols. The network(s) may include one or more of a LAN, a wide area network (WAN), a direct connection such as through a Universal Serial Bus (USB) port, and the like, and may include the set of interconnected networks that make up the Internet. The network(s) may include any communication method or employ any form of machine-readable media for communicating information from one device to another.

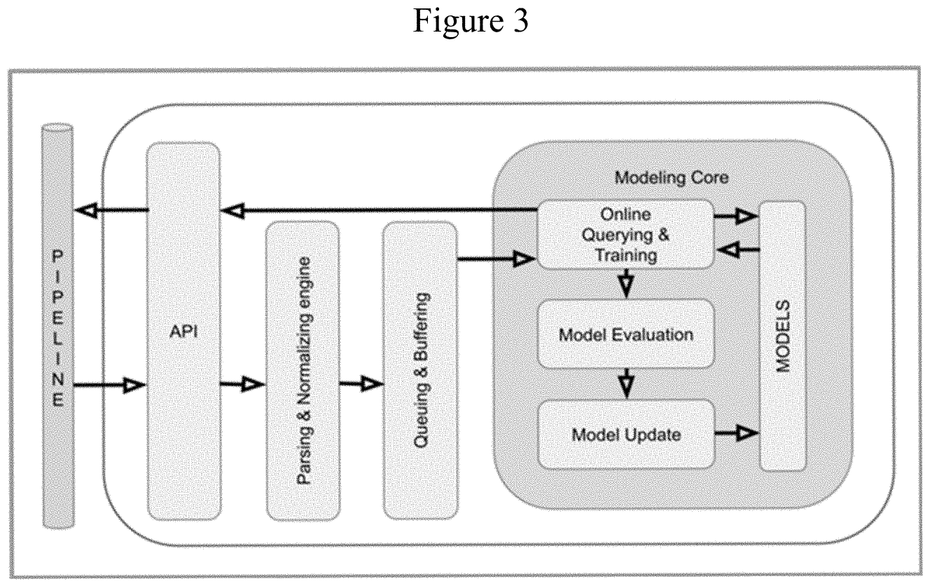

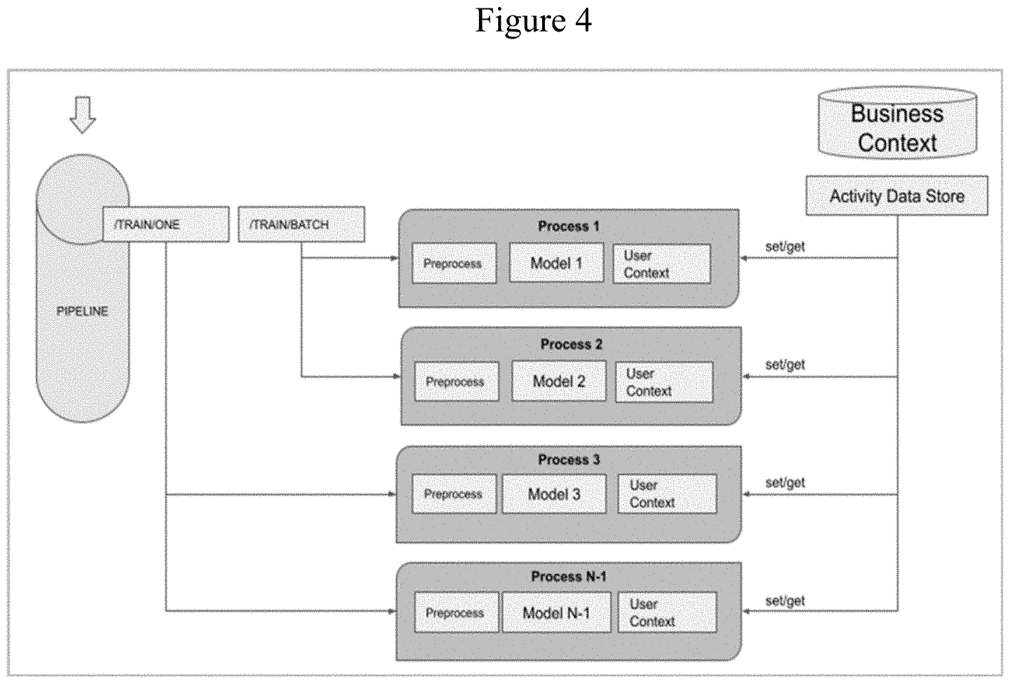

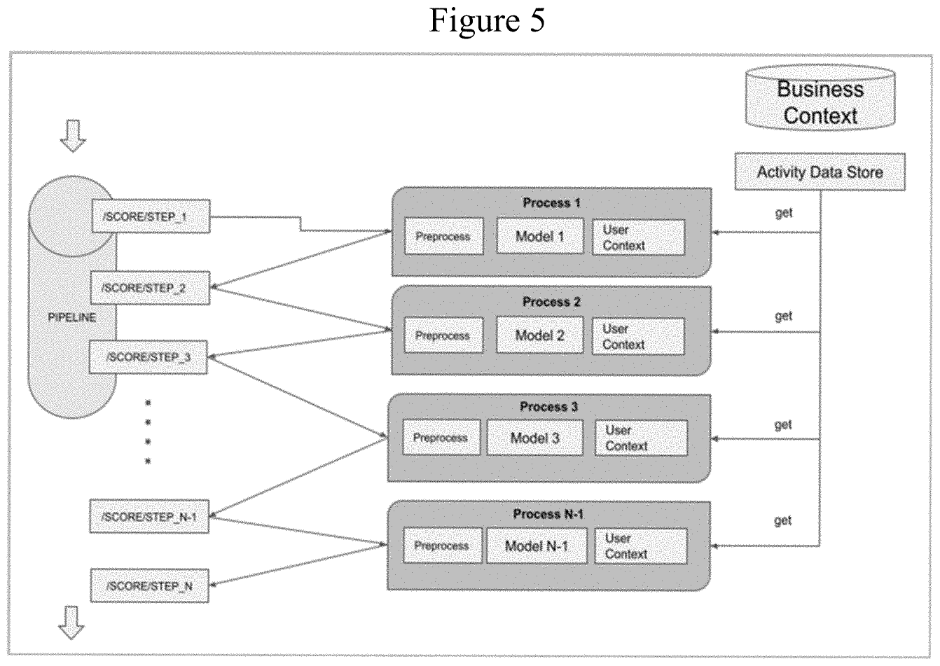

While FIG. 1 illustrates an example network system, FIGS. 2-4 provide additional systems for the modeling. In some embodiments, the engines, models, and handlers may be operated by the anomaly detector 112 from FIG. 1. FIGS. 2-3 illustrate example system architectures for automatically detecting anomalies in users of MCAs. FIG. 4 illustrates one example architecture of a modeling core component for training. FIG. 5 illustrates one example architecture of a modeling core component for a scoring of business process events.

Application programming interface (API) gets log events from the pipeline and returns scores, labels and other results to the pipeline; interacts with all modules of the component.

FIG. 2 illustrates an example system architecture. The process may include a training model with training updates through a “learn_one” model or a “learn_many” model. Further, scoring of business process events may be through a “score_one” or “score_many.” FIG. 2 illustrates the Modeling Engine and one or more Modeling Cores. The Modeling Engine may include an Extractor that listens for events that are provided as an input to the extractor. The events can be extracted by the Extractor as part of an Events Parsing, Events Normalization, and/or Queing & Buffering process.

The results from the Modeling Engine are fed to one or more Modeling Cores. In one embodiment, there may be a Modeling Core for a Scoring Phase and a Modeling Core for a Model Update Phase. For the Scoring Phase, the Modeling Core may include multiple models (e.g. Model A, Model B, and Model C). Each may have a Model Wrapper. The Scoring Phase models may provide input to the Model Update Phase. For the Model Update Phase, the Modeling Core may include multiple models (e.g. Model A, Model B, and Model C). The models may Update context and perform Fading and Pruning.

The modeling core software implementation includes but is not limited to the routines learn_one, learn_many, score_one, score_many, model eval, and others. In other embodiments, the modeling core software implementation includes but is not limited to the routines learn_one, learn_many, score_one, score_many, model_train, model_update, model query, model eval, and others. In some embodiments, the model_train of the model may be implemented through routines called learn_one and learn_many. This may include the initial training of a model, over one specific MCA, by using a machine learning algorithm with specific hyper parameters. It receives the data to be used to train the model, consisting in the parsed, normalized and eventually queued Activity, Security and Audit logs' events; receives the algorithm or algorithms to be used; and receives the hyper parameters that fine tune how the algorithm uses the data to generate the model. The hyper parameters may be specific to each algorithm, and can fine tune the algorithm behavior in terms of number of times to process data, loss function selection, optimization metric(s), among others. The output of the model_train subcomponent is a trained model that can be persisted in storage media for later query or update.

FIG. 3 illustrates another example system architecture. In an alternative embodiment, FIG. 3 illustrates an alternative embodiment from the system architecture of FIG. 2. Specifically, FIG. 2 illustrates the pipeline, API, Parsing and Normalizing engine, Queuing and Buffering, into a Modeling Core. The Modeling Core in FIG. 3 is one example of the modeling cores in FIG. 2.

The update of the model is implemented through two routines called learn_one or learn_many, which update the model with information of one or many events respectively. This implements the additional training of an already generated model, using additional data and both the same algorithm and hyper parameters, among others. It receives the data to be used to train the model, consisting in the parsed, normalized and eventually queued Activity, Security and Audit logs' events; receives the algorithm or algorithms to be used; and receives the hyper parameters that fine tune how the algorithm uses the data to generate the model. The hyper parameters may be specific to each algorithm, and can fine tune the algorithm behavior in terms of number of times to process data, loss function selection, optimization metric(s), among others. The output of the learn_one and learn_many routines is a trained model that can be persisted in storage media for later scoring or update. The model update routines leverage a continual approach, meaning it can be called continuously to keep the model properly updated, considering that previous information should be less relevant than newer information and hence that information can fade (diminish in its importance) over time; this process of information reduction is called fading. The model update routines (learn_one and/or learn_many) also consider that sufficiently old data is not important, hence that information that is older than a certain threshold of time (i.e. 1 year, 18 months, 10 weeks) is deleted from the model; this process of data elimination is called pruning.

The scoring routines (score_one and score_many) implement the utilization of the model to calculate anomaly scores on any data (previously seen or unseen data). The input to the scoring routines is the data to be scored by the model, consisting of the parsed and normalized Activity, Security and Audit logs' events, one by one or in batches. Its output may include an anomaly score for each processed event and an explanation for that score.

The model_eval routine evaluates the model's performance at any time, in order to determine if additional training (by means of a partial ‘model update’) is needed. It receives the model subject to evaluation, validation events used to test the model's performance and the metric and threshold to be applied. It outputs a performance indicator according to the defined metric and performance threshold.

The parsing and normalizing module includes events preprocessing, i.e. aggregation, filtering, normalizing, and encoding. It performs all operations needed to shape the events, which are thereafter fed as an input to the queuing and buffering module. Additional business relevant context is correlated here to transform technical activity into higher-level business terms and business activity. It receives as input the raw events and converts them to a common normalized format. It is also able, if requested by means of its parameters: to filter by any feature; to encode dates following different standards; to create new features by combining existing ones; and to add new features by lookups and correlation of business information.

The queuing and buffering module controls timing. As each module may take a different amount of time to process data, and to avoid data loss, out-of-order data, etc. a queuing/buffering mechanism is implemented. It receives as input the normalized and preprocessed events that are output by the parsing and normalizing module. The events in the queue(s) are consumed by the modeling core component. This module implements the queuing strategies needed by the different algorithms to allow for an efficient online learning mechanism, by accumulating batches of parsed and normalized events. Batch size can be parameterized in order to optimize for one or more of: model training accuracy; resources' efficiency; and scoring speed, among others.

FIG. 4 illustrates an example architecture of a modeling core component for training. There may be multiple processes for training. As discussed, FIG. 2 includes a training process and FIG. 4 illustrates a training example.

FIG. 5 illustrates an example architecture of a modeling core component for a scoring of business process events. The scoring may be part of the process from FIG. 2 in some embodiments.

### Business Risk Scoring

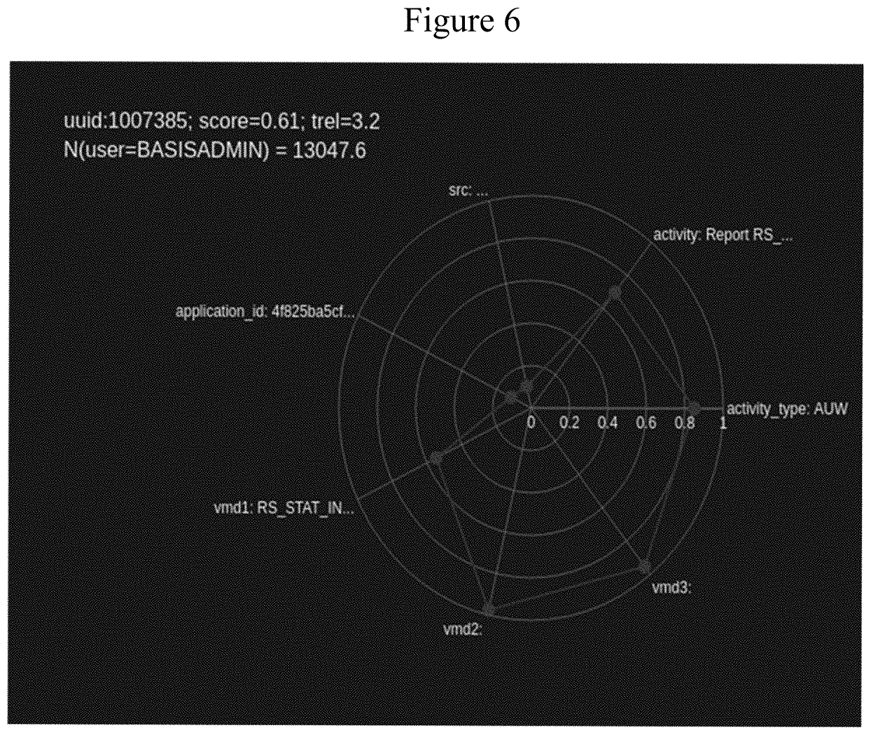

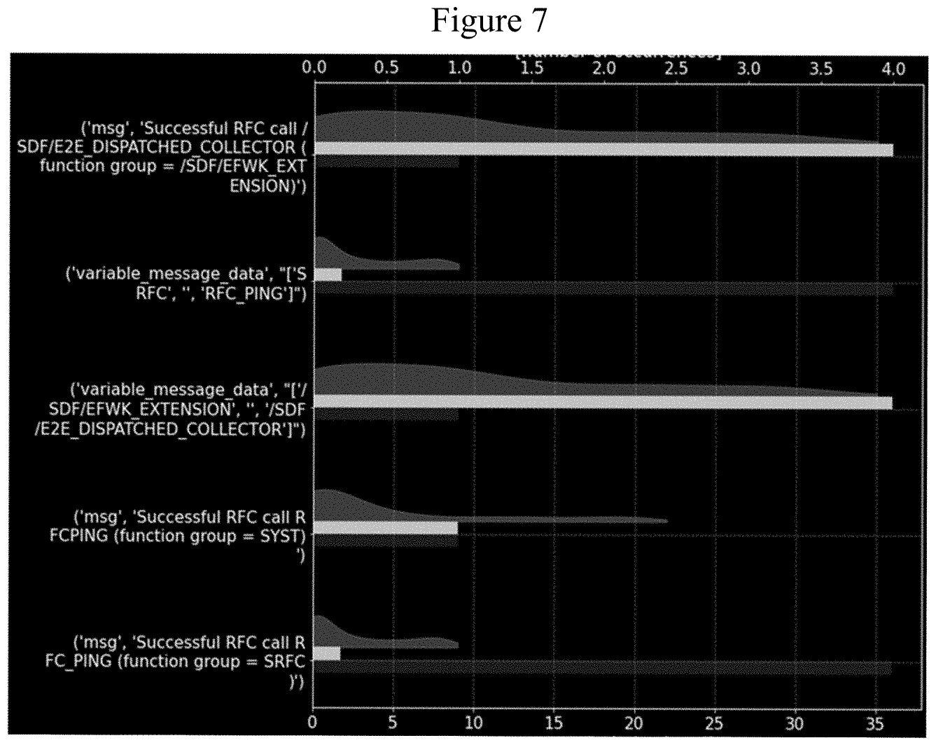

This system provides the ability to score activities by assigning them a degree of anomaly attributed to an event and its context, calculated by a specific model, or an ensemble of models. Additionally, the scoring is designed in such a way that it is simple to explain the values assigned by these models. FIG. 6 illustrates an example contribution of each attribute of a business activity towards a final score of one example model. FIG. 6 shows the different contributions to the score. In this example, each contribution is related to different aspects of the activity from a business perspective and the value of each attribute or feature. For example, the dots closer to the origin means that historically there is a close relationship between that attribute and the user that generated the activity; therefore there is a low contribution to the anomaly score of this event. On the other hand, the dots further from the origin are associated with poor relationship between the user and the attribute value; therefore the contributions tend to be high. FIG. 7 illustrates an example degree of normality of each attribute of a business activity.

Additionally, by combining and weighting different models' outputs, it is possible to supply a single score that expresses the ensemble model agreement.

The meaning of specific details should be construed as examples within the embodiments and are not exhaustive or limiting the invention to the precise forms disclosed within the examples. One skilled in the relevant art will recognize that the invention can also be practiced without one or more of the specific details or with other methods, implementations, modules, entities, datasets, etc. In other instances, well-known structures, computer-related functions or operations are not shown or described in detail, as they will be understood by those skilled in the art.

The discussion above is intended to provide a brief, general description of a suitable computing environment (which might be of different kinds like a client-server architecture or an Internet/browser network) in which the invention may be implemented. The invention will be described in the general context of computer-executable instructions, such as software modules, which might be executed in combination with hardware modules, being executed by different computers in the network environment. Generally, program modules or software modules include routines, programs, objects, classes, instances, components, data structures, etc., that perform particular tasks or implement particular abstract data types. Computer-executable instructions, associated data structures and program modules represent examples of the program code means for executing steps of the method described herein. The particular sequence of such executable instructions, method steps or associated data structures only represent examples of corresponding activities for implementing the functions described therein. It is also possible to execute the method iteratively.

Those skilled in the art will appreciate that the invention may be practiced in a network computing environment with many types of computer system configurations, including personal computers (PC), hand-held devices (for example, smartphones), multi-processor systems, microprocessor-based programmable consumer electronics, network PCs, minicomputers, mainframe computers, laptops and the like. Further, the invention may be practiced in distributed computing environments where computer-related tasks are performed by local or remote processing devices that are linked (either by hardwired links, wireless links or by a combination of hardwired or wireless links) through a communications network. In a distributed computing environment, program modules may be located in local or remote devices, memory systems, retrievals or data storages.

Generally, the method according to the invention may be executed on one single computer or on several computers that are linked over a network. The computers may be general purpose computing devices in the form of a conventional computer, including a processing unit, a system memory, and a system bus that couples various system components including system memory to the processing unit. The system bus may be any one of several types of bus structures including a memory bus or a memory controller, a peripheral bus and a local bus using any of a variety of bus architectures, possibly such which will be used in clinical/medical system environments. The system memory includes read-only memory (ROM) and random access memory (RAM). A basic input/output system (BIOS), containing the basic routines that have the functionality to transfer information between elements within the computer, such as during start-up, may be stored in one memory. Additionally, the computer may also include hard disk drives and other interfaces for user interaction. The drives and their associated computer-readable media provide non-volatile or volatile storage of computer executable instructions, data structures, program modules and related data items. A user interface may be a keyboard, a pointing device or other input devices (not shown in the figures), such as a microphone, a joystick, a mouse. Additionally, interfaces to other systems might be used. These and other input devices are often connected to the processing unit through a serial port interface coupled to the system bus. Other interfaces include a universal serial bus (USB). Moreover, a monitor or another display device is also connected to the computers of the system via an interface, such as a video adapter. In addition to the monitor, the computers typically include other peripheral output or input devices (not shown), such as speakers and printers or interfaces for data exchange. Local and remote computers are coupled to each other by logical and physical connections, which may include a server, a router, a network interface, a peer device or other common network nodes. The connections might be local area network connections (LAN) and wide area network connections (WAN) which could be used within the intranet or internet. Additionally, a networking environment typically includes a modem, a wireless link or any other means for establishing communications over the network.

Moreover, the network typically comprises means for data retrieval, particularly for accessing data storage means like repositories, etc. Network data exchange may be coupled by means of the use of proxies and other servers.

The example embodiments are to be considered in all respects only as illustrative and not restrictive. The scope of the invention is, therefore, indicated by the appended claims rather than by this description. All changes which come within the meaning and range of equivalency of the claims are to be embraced within their scope.

1. A method for anomaly detection for one or more events, the method comprising:
generating a detection model based on user behavior;
updating, dynamically, the detection model based on additional user behavior from the detection model; and
utilizing the detection model to generate a score reflecting an anomaly level of at least one of the events.

2. The method of claim 1, wherein the generating is further comprising:
training a machine learning model based on the user behavior.

3. The method of claim 2, wherein the generating is further comprising:
training the machine learning model based on the additional user behavior.

4. The method of claim 1, wherein the updating is further comprising:
continue training a machine learning model based on the additional user behavior.

5. The method of claim 4, wherein the updating utilizes fading prior information and pruning old information.

6. The method of claim 1, wherein the user behavior comprises technical logs, business activity logs, security logs, or audit trails.

7. The method of claim 1, wherein the score is generated for each of the events from the past user behavior and each of the events from the additional user behavior.

8. The method of claim 1, further comprising:
classifying the events based on the scores generated by the detection model.

9. A non-transitory computer-readable storage medium, storing a computer program comprising program instructions, wherein the program instructions are executed by a processor configured for:
generating a detection model based on user behavior;
updating, dynamically, the detection model based on additional user behavior from the detection model; and
utilizing the detection model to generate a score reflecting an anomaly level of at least one of the events.

10. The method of claim 9, wherein the generating is further comprising:
training a machine learning model based on the user behavior.

11. The method of claim 10, wherein the generating is further comprising:
training the machine learning model based on the additional user behavior.

12. The method of claim 9, wherein the updating is further comprising:
continue training a machine learning model based on the additional user behavior.

13. The method of claim 12, wherein the updating utilizes fading prior information and pruning old information.

14. The method of claim 9, wherein the user behavior comprises technical logs, business activity logs, security logs, or audit trails.

15. The method of claim 9, wherein the score is generated for each of the events from the past user behavior and each of the events from the additional user behavior.

16. The method of claim 9, further comprising:
classifying the events based on the scores generated by the detection model.

17. A system comprising:
a system under analysis;
an anomaly detector for anomaly detection for one or more events, the anomaly detector configured for:
generating a detection model based on user behavior by training a machine learning model based on the user behavior;
updating, dynamically, the detection model based on additional user behavior from the detection model by continuing training of the machine learning model based on the additional user behavior;
utilizing the detection model to generate a score reflecting an anomaly level of at least one of the events; and
classifying the events based on the scores generated by the detection model.

18. The system of claim 17 further comprising:
a business log storage providing the user behavior.

19. The system of claim 17 further comprising:
audit trails providing the user behavior.

20. The system of claim 17 further comprising:
an administrator for retrieving the score.
